(19) United States
(12) Patent Application Publication
(10) Pub. No.: US 2011/0085560 A1
(43) Pub. Date: Apr. 14, 2011

(54) System and Method for Implementing a Virtual Switch

(75) Inventors: Gaurav Chawla, Austin, TX (US); Saikrishna Kotha, Austin, TX (US)

(73) Assignee: DELL PRODUCTS L.P., Round Rock, TX (US)

(21) Appl. No.: 12/577,448

(22) Filed: Oct. 12, 2009

(51) Int. Cl. H04L 12/56

(52) U.S. Cl. 370/401

(57) ABSTRACT

Systems and methods for implementing a virtual switch are disclosed. A system may include a plurality of information handling systems and a network of physical switches interfaced between the plurality of information handling systems and configured to communicatively couple the plurality of information handling systems to each other. The network of physical switches may include a plurality of participating physical switches. The plurality of participating physical switch may be configured as a virtual switch such that the plurality of participating physical switches appears as a single logical switch to devices external to the plurality of participating physical switches.

### TECHNICAL FIELD

The present disclosure relates in general to networking and communication, and more particularly to implementation of a virtual switch in a network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are often disposed in networking systems which communicatively couple numerous information handling systems together, sometimes over vast distances. As the prevalence and speed of such networks increase, increasing numbers of information handling systems and other devices are being coupled to such networks, leading to increasing numbers of network switches and ports, which in turn leads to increased management complexity for such networks.

Traditional approaches to mitigating the problem of increased network management complexity include the use of physical stacked switches and chassis switches. Physical stack switches and chassis switches are large physical switches created by physically coupling multiple smaller switches (e.g., in a ring, star, or mesh topology). However, such approaches only partially solve the problem of increased network complexity, as the number of edge switches often increases even with the use of physical stacked switches and chassis switches, and network administrators must still manage a large number of switches.

### SUMMARY

In accordance with the teachings of the present disclosure, the disadvantages and problems associated with switch management in a networking system have been substantially reduced or eliminated.

In accordance with one embodiment of the present disclosure, a method for implementing a virtual switch is provided. The method may include identifying a plurality of participating physical switches for membership in the virtual switch and configuring the participating physical switches such that the virtual switch appears as a single logical switch to devices external to the virtual switch.

In accordance with another embodiment of the present disclosure, a virtual switch may include a plurality of participating physical switches. The participating physical switches may be configured such that the virtual switch appears as a single logical switch to devices external to the virtual switch.

In accordance with a further embodiment of the present disclosure, a system may include a plurality of information handling systems and a network of physical switches interfaced between the plurality of information handling systems and configured to communicatively couple the plurality of information handling systems to each other. The network of physical switches may include a plurality of participating physical switches. The plurality of participating physical switch may be configured as a virtual switch such that the plurality of participating physical switches appears as a single logical switch to devices external to the plurality of participating physical switches.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system of networked information handling systems, in accordance with certain embodiments of the present disclosure;

FIG. 2 illustrates a block diagram of an example network of switches, in accordance with certain embodiments of the present disclosure;

FIG. 3 illustrates a flow chart of a method for implementing a virtual switch, in accordance with certain embodiments of the present disclosure; and

FIG. 4 illustrates an example Ethernet Frame including a virtual switch packet data unit, in accordance with certain embodiments of the present disclosure.

### DETAILED DESCRIPTION

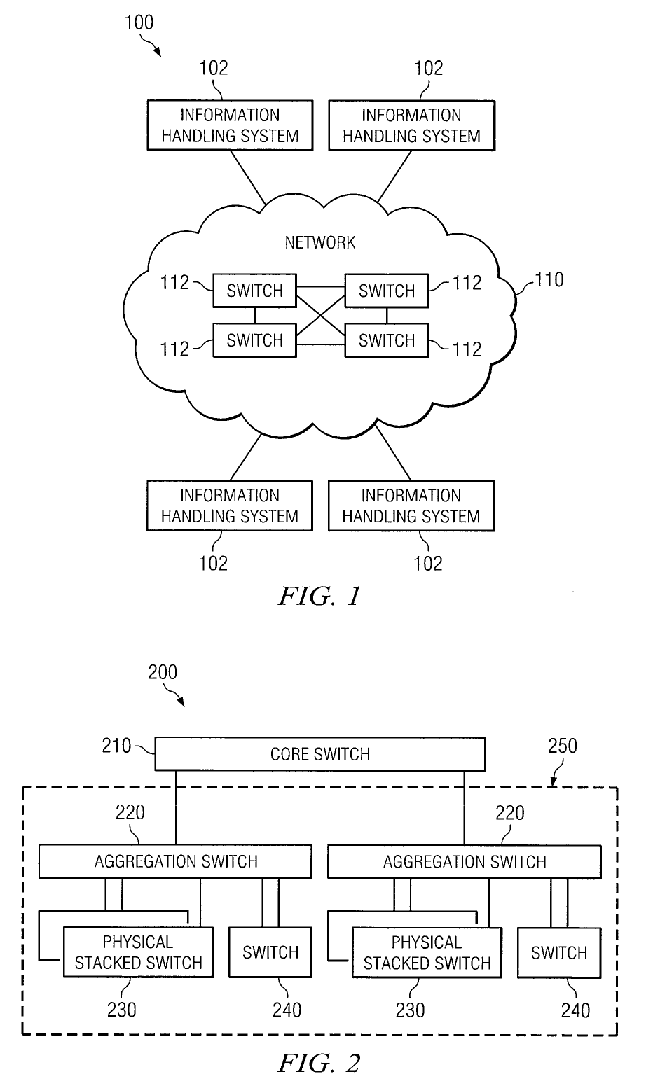

Preferred embodiments and their advantages are best understood by reference to FIGS. 1-4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example system 100 of networked information handling systems 102, in accordance with certain embodiments of the present disclosure. As depicted, system 100 may include one or more information handling systems 102 (referred to generally herein as information handling system 102 or information handling systems 102) and a network 110. Each information handling system 102 may generally be configured to receive data from and/or transmit data to one or more other information handling systems 102 via network 110. One or more information handling systems 102 may in certain embodiments, comprise a server. In the same or alternative embodiments, one or more information handling systems 102 may comprise a storage resource and/or other computer-readable media (e.g., a storage enclosure, hard-disk drive, tape drive, etc.) operable to store data. In other embodiments, one or more information handling systems 102 may comprise a peripheral device, such as a printer, sound card, speakers, monitor, keyboard, pointing device, microphone, scanner, and/or “dummy” terminal, for example. In addition, although system 100 is depicted as having four information handling systems 102, it is understood that system 100 may include any number of information handling systems 102.

Network 110 may be a network and/or fabric configured to communicatively couple information handling systems 102 to one another. In certain embodiments, network 110 may include a communication infrastructure, which provides physical connections, and a management layer, which organizes the physical connections of information handling systems 102 and switches 112. Network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 110 may transmit data using any storage and/or communication protocol, including without limitation, Fibre Channel, Frame Relay, Ethernet Asynchronous Transfer Mode (ATM), Internet protocol (IP), or other packet-based protocol, and/or any combination thereof. Network 110 and its various components may be implemented using hardware, software, or any combination thereof.

As depicted in FIG. 1, network 110 may include one or more switches 112. Each switch 112 may generally be configured to communicatively couple information handling systems 102 to each other, and may further be operable to inspect packets as they are received, determine the source and destination of each packet (e.g., by reference to a routing table), and forward each packet appropriately. One or more of switches 112 may include a plurality of input (or ingress) ports for receiving data, a plurality of output (or egress) ports for transmitting data, and a controller for inspecting received packets and routing the packets accordingly based on packet control information. Although FIG. 1 depicts network 110 comprising four switches 112, network 110 may include any number of switches.

FIG. 2 illustrates a block diagram of an example network 200 of switches, in accordance with certain embodiments of the present disclosure. As depicted in FIG. 2, network 200 may comprise one or more core switches 210, one or more aggregation switches 220, one or more physical stacked switches 230, and one or more standalone switches 240. One or more of core switches 210, aggregation switches 220, physical stacked switches 230 and standalone switches 240 may be identical or similar to switches 112 of FIG. 1.

As shown in FIG. 2, core switches 210, aggregation switches 220, physical stacked switches 230 and standalone switches 240 may be organized in a hierarchy. Many networks are commonly built using a three-layer hierarchy: (1) access switches (e.g., physical stacked switches 230 and/or standalone switches 240), (2) aggregation (or distribution) switches (e.g., aggregation switches 220), and (3) core switches (e.g., core switches 210). Access switches are typically those which are directly coupled to information handling systems (e.g., typically with no intermediate switches between the access switches and information handling systems), and are often configured for network security and/or quality of service. Aggregation switches are often interfaced between access switches and core switches, and are often configured to aggregate multiple access switches and perform routing, filtering, and/or other operations. Core switches are often interfaced between aggregation switches and other core switches, and are often configured to be highly fault tolerant, highly available, and to have the ability to quickly forward data packets.

In accordance with the present disclosure, multiple physical switches (e.g., one or more aggregation switches 220, one or more physical stacked switches 230 and one or more standalone switches 240), may be combined to form a virtual switch 250 which appears to a network administrator, information handling system 102, or another switch as a single logical switch. In certain embodiments, physical switches participating in virtual switch 250 may logically appear as line cards and/or other components of a switch.

The creation of virtual stacked switch 250 may enable an administrator to manage virtual switch 250 as a single entity, thus reducing management complexity, as described in greater detail below. In addition or alternatively, virtual stack 250 may allow for seamless migration of port-specific network configuration profiles from one port to another in virtualized environments.

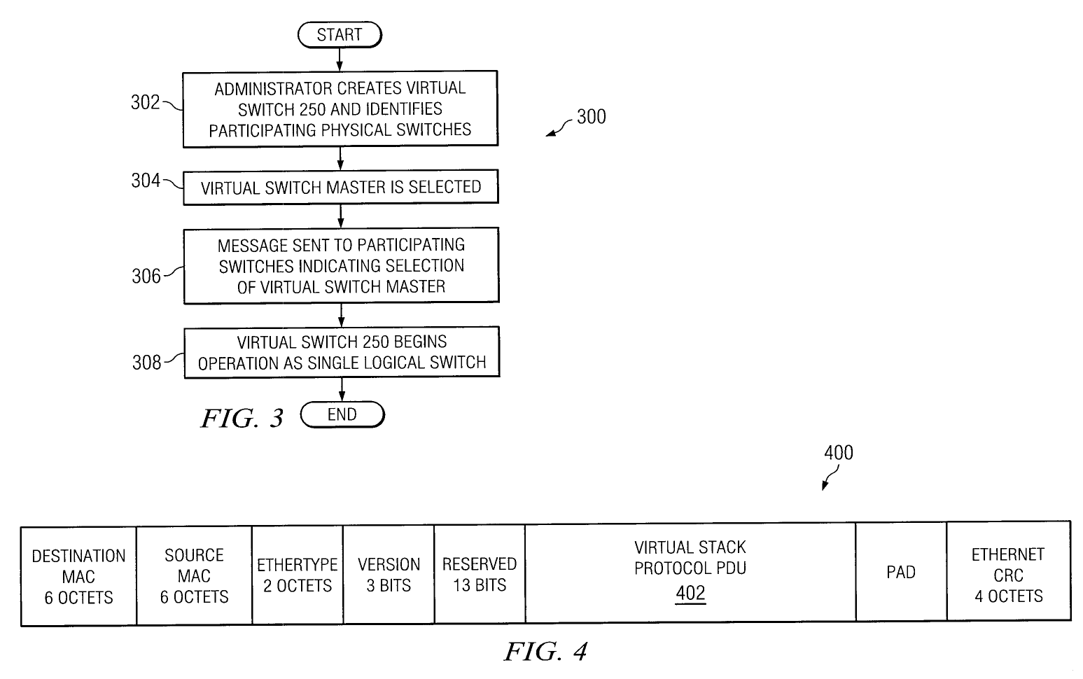

FIG. 3 illustrates a flow chart of a method 300 for implementing virtual switch 250, in accordance with an embodiment of the present disclosure. According to one embodiment, method 300 may begin at step 302. As noted above, teachings of the present disclosure may be implemented in a variety of configurations of system 100 and system 200. As such, the initialization point for method 300 and the order of the steps 302-308 comprising method 300 may depend on the implementation chosen.

At step 302, an administrator may create virtual switch 250 and identify participating physical switches (e.g., one or more aggregation switches 220, one or more physical stacked switches 230 and one or more standalone switches 240) for virtual switch 250. After creation of virtual switch 250, the administrator may add or remove physical switches as desired.

At step 304, one of the participating physical switches may be selected as a virtual switch master. The virtual switch master may serve to manage and/or control the virtual switch and/or its participating physical switches. In some embodiments, the virtual switch master may be selected automatically. For example, after an administrator identifies the participating physical switches, the participating switches may perform an election process to determine the virtual switch master. As a specific example, the election process may select the participating physical switch having the highest processing and/or memory capacity. In other embodiments, the virtual switch master may be selected manually. For example, the administrator may select the switch to serve as the virtual switch master. In yet other embodiments, a hybrid automatic-manual election process may be employed. For example, an administrator may select one or more candidates for the virtual switch master, and such selected switches may participate in an election process. Selection processes such as those described above may be utilized at other times as well (e.g., when a new participating physical switch is added, when the existing virtual switch master is removed or fails, etc.).

At step 306, after a virtual switch master is selected, the virtual switch master may communicate a message or advertisement to the other participating physical switches regarding the selection of the virtual switch master.

At step 308, virtual switch 250 may begin operation as a single logical switch, including the management and/or control of participating physical switches by the selected virtual switch master. In some embodiments, virtual switch 250 may have a unique identifier (e.g., a MAC address) by which it may be identified by information handling systems and switches external to virtual switch 250. In such embodiments, such unique identifier may be the unique identifier of the virtual switch master.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using system 100, system 200, or any other system operable to implement method 300. In certain embodiments, method 300 may be implemented partially or fully in software and/or firmware embodied in computer-readable media.

In operation, the virtual switch master may manage the participating physical switches of virtual switch 250. For example, the virtual switch master may manage the participating physical switches as if they are line cards in a chassis.

In some embodiments, the virtual switch master may address each of the participating physical switches using a hierarchical addressing scheme. For example, each port of the various participating physical switches may be addressed by a 3-tuple addressing scheme <VS#, PS#, Port#>. Each participating physical switch may be assigned a unique VS#, which may be global to the virtual switch 250. If a participating physical switch is a physical stack switch (e.g., a physical stack switch 230), each component switch of the physical stack switch may be assigned a PS#, which may be global to the physical stack switch. Each switch port may be addressed by a Port#, which is local to the switch.

In the same or alternative embodiments, each participating physical switch of virtual switch 250 may be identified by a unique identifier (e.g., by a Media Access Control (MAC) address). Such unique identifiers may be used to exchange virtual switch management messages among the various participating physical switches. A reserved broadcast identifier (e.g., a Multicast MAC address) may also be used to communicate multicast/broadcast packets related to virtual switch management. Management messages may be communicated among the various participating physical switches in accordance with any suitable protocol or standard. For example, FIG. 4 depicts an example Ethernet frame 400 including a virtual switch packet data unit (PDU) 402, wherein the PDU 402 may include data or instructions to be communicated from one participating physical switch to another.

As described above, a virtual switch may manage the participating physical switches as if they are line cards in a chassis. Accordingly, the virtual switch master may be configured to maintain the synchronization of the switching databases of each of the participating physical switches. Advantageously, this may enable seamless migration of network profiles from one physical port of the virtual switch to another. For example, if participating physical switches of two or more physical servers make up virtual switch 250, and a virtual machine running on one server is migrated to another, the physical destination switch may learn the migrated virtual machine's MAC address, which may appear logically as a MAC address station migration. In addition, a virtual stack master may migrate the network profile for the virtual machine from the old switch port to the new switch port, and these operations may appear as seamless or invisible to an administrator.

Although the present disclosure has been described in detail, it should be understood that various changes, substitutions, and alterations can be made hereto without departing from the spirit and the scope of the disclosure as defined by the appended claims.

What is claimed is:

1. A method for implementing a virtual switch, comprising:
identifying a plurality of participating physical switches for membership in the virtual switch; and
configuring the participating physical switches such that the virtual switch appears as a single logical switch to devices external to the virtual switch.

2. The method of claim 1, further comprising selecting a virtual switch master from the plurality of participating physical switches, wherein the virtual switch master is configured to manage the virtual switch and its participating physical switches.

3. The method of claim 2, wherein selecting the virtual switch master includes automatically electing the virtual switch master from at least a portion of the plurality of participating physical switches based on one or more characteristics of the individual switches comprising the portion of participating physical switches.

4. The method of claim 2, wherein selecting the virtual switch master includes manual selection of the virtual switch master.

5. The method of claim 1, further comprising communicating management messages among the plurality of participating physical switches, wherein ports of each of the plurality of participating physical switches are addressed in accordance with a tuple, the tuple including:
a first unique identifier field associated with each participating physical switch, the first unique identifier field global to the virtual switch;
a second unique identifier field associated with each component switch of each participating physical switch that is a physical stack switch, the second unique identifier field global to the physical stack switch; and
a third unique identifier field associated with each port of each participating physical switch, the third unique identifier field local to the participating physical switch.

6. The method of claim 1, further comprising communicating management messages among the plurality of participating physical switches via an Ethernet frame, wherein the Ethernet frame includes an encapsulated packet data unit having virtual switch-specific data.

7. The method of claim 1, wherein the plurality of participating physical switches includes at least one of an aggregation switch, a physical stacked switch, a standalone physical switch, and an access switch.

8. A virtual switch comprising a plurality of participating physical switches, wherein the participating physical switches are configured such that the virtual switch appears as a single logical switch to devices external to the virtual switch.

9. The virtual switch of claim 8, wherein one of the plurality of participating physical switches is selected as a virtual switch master, wherein the virtual switch master is configured to manage the virtual switch and its participating physical switches.

10. The virtual switch of claim 9, wherein selection of the virtual switch master includes an election process including at least a portion of the plurality of participating physical switches, wherein the virtual switch master is elected based on one or more characteristics of the individual switches comprising the portion of participating physical switches.

11. The virtual switch of claim 9, wherein selection of the virtual switch master includes manual selection of the virtual switch master.

12. The virtual switch of claim 8, wherein at least one of the plurality of participating physical switches is configured to communicate management messages to the other participating physical switches, wherein ports of each of the plurality of participating physical switches are addressed in accordance with a tuple, the tuple including:
a first unique identifier field associated with each participating physical switch, the first unique identifier field global to the virtual switch;
a second unique identifier field associated with each component switch of each participating physical switch that is a physical stack switch, the second unique identifier field global to the physical stack switch; and
a third unique identifier field associated with each port of each participating physical switch, the third unique identifier field local to the participating physical switch.

13. The virtual switch of claim 8, wherein at least one of the plurality of participating physical switches is configured to communicate management messages to the other participating physical switches via an Ethernet frame, wherein the Ethernet frame includes an encapsulated packet data unit having virtual switch-specific data.

14. The virtual switch of claim 8, wherein the plurality of participating physical switches includes at least one of an aggregation switch, a physical stacked switch, a standalone physical switch, and an access switch.

15. A system including:
a plurality of information handling systems; and
a network of physical switches interfaced between the plurality of information handling systems and configured to communicatively couple the plurality of information handling systems to each other;
wherein the network of physical switches includes a plurality of participating physical switches, the plurality of participating physical switch configured as a virtual switch such that the plurality of participating physical switches appears as a single logical switch to devices external to the plurality of participating physical switches.

16. The system of claim 15, wherein one of the plurality of participating physical switches is selected as a virtual switch master, wherein the virtual switch master is configured to manage the virtual switch and its participating physical switches.

17. The system of claim 15, wherein selection of the virtual switch master includes one of:
an election process including at least a portion of the plurality of participating physical switches, wherein the virtual switch master is elected based on one or more characteristics of the individual switches comprising the portion of participating physical switches; and
manual selection of the virtual switch master.

18. The system of claim 15, wherein at least one of the plurality of participating physical switches is configured to communicate management messages to the other participating physical switches, wherein ports of each of the plurality of participating physical switches are addressed in accordance with a tuple, the tuple including:
a first unique identifier field associated with each participating physical switch, the first unique identifier field global to the virtual switch;
a second unique identifier field associated with each component switch of each participating physical switch that is a physical stack switch, the second unique identifier field global to the physical stack switch; and
a third unique identifier field associated with each port of each participating physical switch, the third unique identifier field local to the participating physical switch.

19. The system of claim 15, wherein at least one of the plurality of participating physical switches is configured to communicate management messages to the other participating physical switches via an Ethernet frame, wherein the Ethernet frame includes an encapsulated packet data unit having virtual switch-specific data.

20. The system of claim 15, wherein the plurality of participating physical switches includes at least one of an aggregation switch, a physical stacked switch, a standalone physical switch, and an access switch.
